(19) United States
(12) Patent Application Publication
(10) Pub. No.: US 2009/0209230 A1
(43) Pub. Date: Aug. 20, 2009

(54) Accessing user interactive electronic communications devices

(76) Inventor: Tony Liu, Pontyypridd (GB)

Correspondence Address: STOUT, UXA, BUYAN & MULLINS LLP, 4 VENTURE, SUITE 300, IRVINE, CA, 92618, US

(21) Appl. No.: 10/592,453

(22) PCT Filed: Mar. 10, 2005
(86) PCT No.: PCT/GB05/00929

§ 371 Date: Oct. 26, 2007

(30) Foreign Application Priority Data
Apr. 10, 2004 (GB) 0405370.8
Dec. 2, 2004 (GB) 0426452.9

(51) Int. Cl. H04M 3/16

(52) U.S. Cl. 455/410

(57) ABSTRACT

An accessing system for a user interactive electronic communications device is disclosed. The accessing system comprises a general data interactive zone accessible via a first user input access protocol and a secure data interactive zone accessible via a security user input access protocol. The system does not prompt the user to input the secure user access protocol and so the existence of the secure zone is only revealed when the secure user access protocol is input.

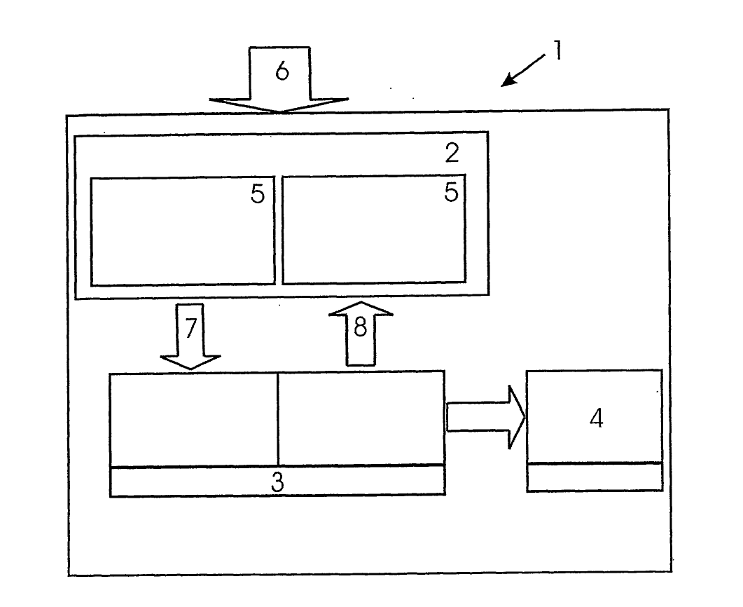

The present invention relates to an accessing system and method for user interactive electronic communications devices.

Security of stored data is an issue for electronic communications devices that may be stolen or lost. Many such devices contain confidential personal or commercial information.

An improved accessing/operating system for a user interactive electronic communications device has now been devised.

According to the present invention, there is provided an accessing system for a user interactive electronic communications device, the accessing system including a general data interactive zone, accessible via a first user input access protocol and a secure data interactive zone accessible via a security user input access protocol.

It is preferred that the system does not prompt the user to input said security user access protocol to prevent openly acknowledging the existence of the secure zone.

It is also preferred that the system includes address register means, addresses being tagged or otherwise identified to ensure selection and allocation of incoming and/or outgoing data in either the general data interactive zone or the secure data interactive zone.

The term address should be read as comprising any form of contact identifier for specific individuals such a telephone number, contact device address, e-mail address or similar.

The system of the present invention enables a hidden zone (including electronic data folders files or the like) to be provided for the device. The hidden zone cannot be accessed without input of the security user input access protocol. The system is such that the presence of the hidden zone is not suggested or hinted at by normal interaction with the device using the first (normal use) user input access protocol.

For example a standard means of interacting with a mobile phone is to use a menu display and control input keys to access menu functions of the phone. In accordance with the invention such interaction would represent access to the general interactive data zone, the interaction via the input keys and menu defining the first (normal use) input access protocol. A mobile phone including the accessing system of the present invention would however further include a second level interaction mode in which the hidden zone (secure data interactive zone) can be accessed by a security input protocol. For example pressing a hot key followed by a personal identification number (PIN) on the device, specifically assigned to the device may enable the secure data interactive zone to be accessed.

The address register means and tagged/identified addresses enables security identified addressed messages to be appropriately assigned to the secure zone or the general zone. Messages, addresses etc assigned to the secure zone cannot be accessed other than via the security input protocol. In the event that the device is stolen or otherwise misappropriated the secure zone cannot not be accessed without knowledge of the security user input access protocol. Furthermore, because the device can be accessed via the general (first) user input access protocol in the normal way there is nothing to suggest the presence of the security zone accessing system being present on the device.

Beneficially, therefore the system identifies address data for incoming and outgoing data and if the address data corresponds to a secure data tagged address assigns the data to the secure data interactive zone in preference to the general zone.

The system preferably monitors for incoming data, identifies sender address a data and compares with an address register in order to ascertain whether the incoming data should be assigned to the secure data interactive zone or the general data interactive zone. It is desirable that communication addresses to be securely treated are input-able into the address register by a user.

In the system of the present invention, system access via the security user input access protocol enables data held in the secure data interactive zone to be accessed. Data held at the general data interactive zone can beneficially be accessed without use of the security user input access protocol.

In one embodiment in accordance with the invention, the data is message data. In a particular embodiment the data is arranged to be presented at an output display of the device as text (alpha-numeric) data.

In one embodiment the data is arranged to be presented at an output display as image data (for example video or photographic).

In one embodiment the secure data interactive zone includes files or registers for storing separately text and image data.

In one embodiment the secure data interactive zone is capable of storing user inputted data other than communication address data.

The invention is applicable to a variety of electronic communication devices including wireless and wire connected devices. Communication devices capable of data receipt (text, image or otherwise) and/or data transmission are envisaged as within the compass of the invention.

According to a further aspect the present invention provides a user interactive communications device having an operating system including a general data interactive zone, accessible via a first user input access protocol and a secure data interactive zone accessible via a security user input access protocol.

According to a further aspect, the present invention provides a method of call/message handling for an electronic communications device, the method comprising:
detecting an incoming call/message;
identifying the sender address for the incoming call/message;
comparing the sender address to a register of addresses; and
assigning the call/message to either:
   a general data interactive zone of the device, accessible via a first user input access protocol, or
   a secure data interactive zone accessible via a security user input access protocol,
dependent upon whether the address is flagged for secure or general handling.

The invention will now be further described by way of example only and with reference to the accompanying drawing which is a schematic view of an electronic device according to the invention utilising an accessing system and method in accordance with the invention.

Referring to the drawing there is shown en electronic communications device platform 1, which for ease of explanation will be described as a mobile phone platform, particularly a mobile phone including SMS, MMS, SML, internet, e-mail or other messaging or data communication functions and capability. Whilst described in this context, it should be readily appreciated by those skilled in the art that the invention is equally applicable to, and realisable for other electronic communications devices.

The accessing system of the present system is installed either as part of the platform operating system 2 or may be downloaded or otherwise subsequently installed to run in tandem with the platform operating system of the device. In the configuration shown in the drawing the system has been downloaded installed to run in tandem with the platform operating system 2 of the device. The system architecture features important to operation of the system of the present invention operating in tandem with the standard operating system 2 of the device are the security call handler 3 and the security data interactive zone 4.

The standard platform operating system 2 enables call/message data assigned to the general data interactive zone 5 to be accessed. This is typically via a menu display and control input keys of the device to access menu functions of the phone.

This is notwithstanding a PIN security access as is generally known in the art, which is operational such that once the PIN access has been established access is permitted to the full functionality of the device. In this respect the operating system and the phone device operates in a similar manner to devices generally known in the art. The present invention, in addition provides the security data interactive zone 4 to which call/message and other secure quality data may be assigned. The call handler 3 and/or security data interactive zone 4 includes a register of secure quality addressees, flagged to ensure that any incoming or outgoing calls/messages from or to security flagged addresses are assigned to the security data interactive zone 4. User access to the security data interactive zone 4 is prohibited unless a specific security input protocol is used. For example pressing a hot key followed by a personal identification number (PIN) on the device, specifically assigned to the device may enable the secure data interactive zone 4 to be accessed. Additionally or alternatively, the security input protocol may include biometric or other personal data input such as voice recognition, iris or fingerprint scanning or DNA analysis.

The address register and tagged/identified addresses enables security identified address calls/messages to be appropriately assigned to the security data interactive zone 4 or the general data interactive zone 5. Messages, addresses etc assigned to the secure zone cannot be accessed other than via the security input protocol. In the event that the device is stolen or otherwise misappropriated the secure zone cannot not be accessed without knowledge of the security user input access protocol. Furthermore, because the device can be accessed via the general (first) user input access protocol in the normal way there is nothing to suggest the presence of the security zone accessing system being present on the device.

In operation to receive an incoming call in accordance with the present invention, an incoming call 6 is received into the standard device platform operating system 2. The security call handler 3 detects and intercepts the incoming call at 7 before the platform operating system actuates the user message received alert. The call handler 3 determines whether the message is to be treated securely or non-securely assigns the message appropriately. If the send address of the incoming call is recognised as one flagged by the device accessing system for secure handling, then the message is assigned to the security interactive data zone. In such circumstances no call/message received alert is actuated and the device acts to all intents as if no call/message has been received. Alternatively if the send address of the incoming call is not recognised as flagged for secure handling, then the call handler 3 hands the call/message back to the platform operating system at 8. Thereafter the non-secure call/message is treated in a standard way by the device platform operating system 2, the call/message being assigned to the general data interactive zone 5 and the call alert operating to notify the owner of the device that an incoming call/message event has occurred.

Similarly if an outgoing call/message is made to an addressee flagged for secure communication, then the outgoing call/message is assigned to the general data interactive zone 4.

Addressees may be flagged for secure communication either by direct user inputting as secure tagged or by transferring a call/message from the general data interactive zone 5 to the security interactive data zone 4. Once access has been gained to the security interactive data zone 4, by means of using the security input access protocol, the security data interactive zone may be interacted with in a similar manner to the means of accessing the general data zone, using typically menu functionality for the security data zone in combination with control input keys. The call/message data stored may be text data files or image (photo or video data files) or other message data (such as audio files, or multimedia data files).

Non call/message data may be input into the security data interactive zone in order to keep the data secret. Such data may relate to diary appointments, memos, or other electronically stored document or other data such as video or audio/sound files.

In circumstances where the accessing system is installed to rum in tandem with the device platform operating system, the initialisation and first running of the accessing system is tied to a unique coded identifier. The accessing system may be downloaded by wireless data transfer to the device. Upgrades and updates may also be installed in a similar manner.

1. An accessing system for a user interactive electronic communications device, the accessing system comprising a general data interactive zone, accessible via a first user input access protocol and a secure data interactive zone accessible via a security user input access protocol.

2. An accessing system according to claim 1, wherein said accessing system does not prompt the user to input said security user input access protocol.

3. An accessing system according to claim 1, wherein said general interactive data zone does not indicate the presence of the secure zone.

4. An accessing system according to claim 1, wherein the presence of said secure zone is only revealed when said secure access protocol is input.

5. An accessing system according to claim 1, wherein the system includes address register means, addresses being tagged or otherwise identified to ensure selection and assignment of incoming and/or outgoing data to either the general data interactive zone or the secure data interactive zone.

6. An accessing system according to claim 5, wherein the system identifies address data for incoming and outgoing data and if the address data corresponds to a secure data tagged address, stores the data to the secure data interactive zone in preference to the general zone.

7. An accessing system according to claim 5, wherein communication addresses to be securely treated are input-able into the address register by a user.

8. An accessing system according to claim 1, wherein the system monitors for incoming data, identifies sender address a data and compares with an address register in order to ascertain whether the incoming data should be allocated to the secure data interactive zone or the general data interactive zone.

9. An accessing system according to claim 1, wherein access via the security user input access protocol enables data held in the secure data interactive zone to be accessed.

10. An accessing system according to claim 1, wherein data held at the general data interactive zone can be accessed irrespective of use of the security user input access protocol.

11. An accessing system according to claim 1, wherein the data is message data.

12. An accessing system according to claim 1, wherein the data is presented at an output display of the device as text (alpha-numeric) data.

13. An accessing system according to claim 1, wherein the data is presented at an output display as image data (for example video or photographic).

14. An accessing system according to claim 1, wherein the secure data interactive zone includes files or registers for storing separately text and image data.

15. An accessing system according to claim 1, wherein the secure data interactive zone is capable of storing user inputted data other than communication address data.

16. An electronic communications device including an accessing system in accordance with claim 1.

17. A user interactive communications device having an operating system including a general data interactive zone, accessible via a first use input access protocol and a secure data interactive zone, accessible via a security user input access protocol.

18. A method of call/message handling for an electronic communications device, the method comprising:
detecting an incoming call/message;
identifying the sender address for the incoming call/message;
comparing the sender address to a register of addresses; and
assigning the call/message to either:
a general data interactive zone of the device, accessible via a first user input access protocol, or
a secure data interactive zone accessible via a security user input access protocol,
dependent upon whether the address is flagged for secure or general handling.
